(19) United States
(12) Patent Application Publication
(10) Pub. No.: US 2016/0240980 A1
(43) Pub. Date: Aug. 18, 2016

(54) ELECTRICAL CONNECTOR ASSEMBLY

(71) Applicant: ALLTOP ELECTRONICS (SUZHOU) LTD., Taicang City (CN)

(72) Inventors: Wang-I YU, Jhonghe City (TW); Mao-Jung HUANG, Jhonghe City (TW)

(73) Assignee: ALLTOP ELECTRONICS (SUZHOU) LTD., Taicang City (CN)

(21) Appl. No.: 14/739,265

(22) Filed: Jun. 15, 2015

(30) Foreign Application Priority Data
Feb. 15, 2015 (CN) 201510082932.X

(51) Int. Cl. H01R 13/6581; H01R 13/502

(52) U.S. Cl. CPC H01R 13/6581; H01R 13/502

(57) ABSTRACT

An electrical connector includes an internal circuit board including a number of first golden fingers at a front end thereof and a number of conductive traces corresponding to the first golden fingers and connected with the first golden fingers respectively, a shielding assembly having a first shell and a second shell together covering top and bottom surfaces of the internal circuit board; and a contact module electrically connected with the internal circuit board.

### BACKGROUND OF THE INVENTION

1. FIELD OF THE INVENTION

The present invention relates to an electrical connector, and more particularly to an electrical connector is easy to fabricate.

2. DESCRIPTION OF RELATED ART

In the end of 2008, USB Implementers Forum (USB-IF) released USB 3.0 specification. The USB 3.0 electrical connector adds two pair of differential contacts and a grounding contact to the USB 2.0 for increasing the speed rate up to 5 GB/s and is backward compatible with USB 2.0. With the development of electronic industry, USB 3.0 can't meet the requirements of consumer. Thus, USB-IF announced USB Type-C connectors which is reversible so that it can be used in any orientation. Moreover, it gets faster and EMI of which is improved. However, USB C-type connector is complicated and challenges the manufacturing and the assembling ability.

Hence, it is desired to provide an electrical connector to overcome the problems mentioned above.

### BRIEF SUMMARY OF THE INVENTION

Accordingly, an object of the present invention is to provide an electrical connector which facilitates to manufacture and has improved transmitting speed.

The present invention is directed to an electrical connector mounting to a mother board and mating with a plug, comprises an internal circuit board including a plurality of first golden fingers at a front end thereof and a plurality of conductive traces corresponding to the first golden fingers and connected with the first golden fingers respectively, a shielding assembly having a first shell and a second shell together covering top and bottom surfaces of the internal circuit board, and a contact module electrically connected with the internal circuit board.

The present invention is directed to an electrical connector for mounting to a mother board and mating with a plug, comprises an internal circuit board including a plurality of first golden fingers at a front end thereof and a plurality of conductive traces connected with the first golden fingers, a shielding assembly including a first shell, a second shell and a third shell, the first and second shell surrounding the top and bottom surfaces of the internal circuit board, a contact module including a plurality of electrical contacts electrically connected with the first golden fingers and the conductive traces of the internal circuit board, and a base securing the electrical contacts, and an insulative housing surrounding the first shell, the second shell and the contact module. The third shell surrounds a rear portion of the insulative housing.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector according to the present invention;

FIG. 2 is a partial exploded view of the electrical connector shown in FIG. 1

FIG. 3 is similar to FIG. 2 but viewed from a different aspect;

FIG. 4 is another partial exploded view of the electrical connector shown in FIG. 1

FIG. 5 is similar to FIG. 4 but viewed from a different aspect;

FIG. 6 is an exploded view of the electrical connector shown in FIG. 1;

FIG. 7 is similar to FIG. 6 but viewed from a different aspect; and

FIG. 8 is an exploded view of the internal circuit board shown in FIG. 6.

### DETAILED DESCRIPTION OF THE PREFERRED EMBODIMENT

Reference will be made to the drawing figures to describe the present invention in detail, wherein depicted elements are not necessarily shown to scale and wherein like of similar elements are designated by same or similar reference numeral through the several views and same or similar terminology.

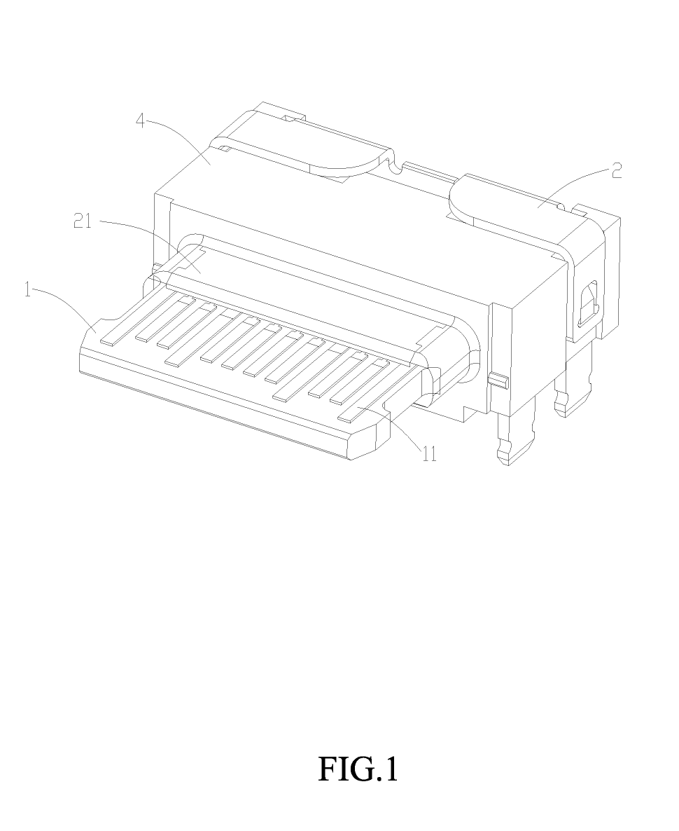

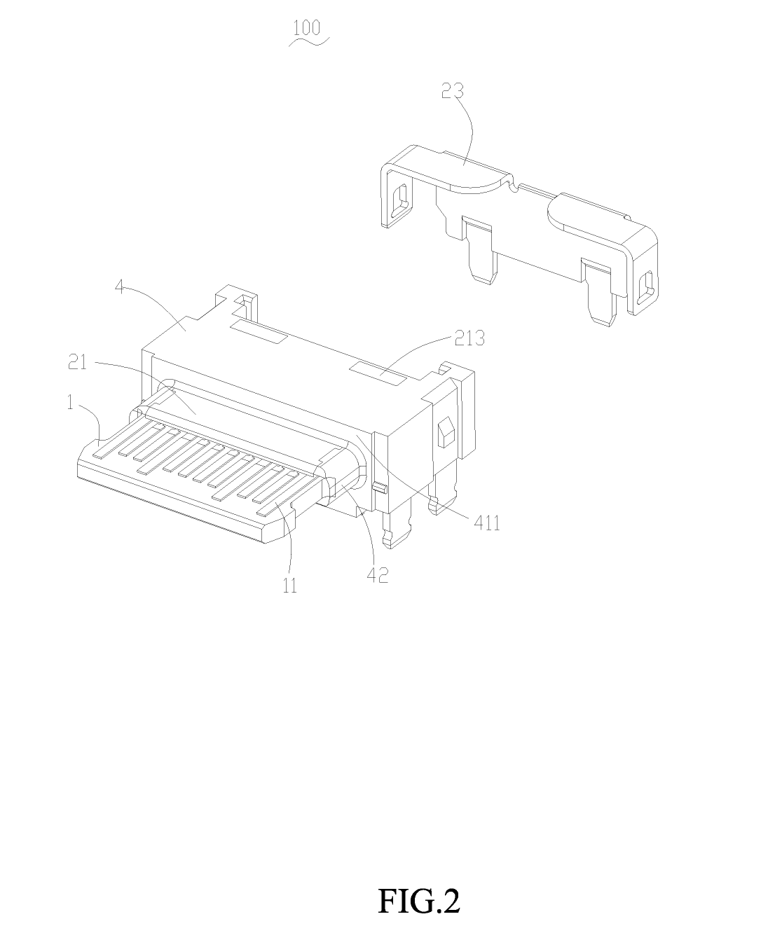

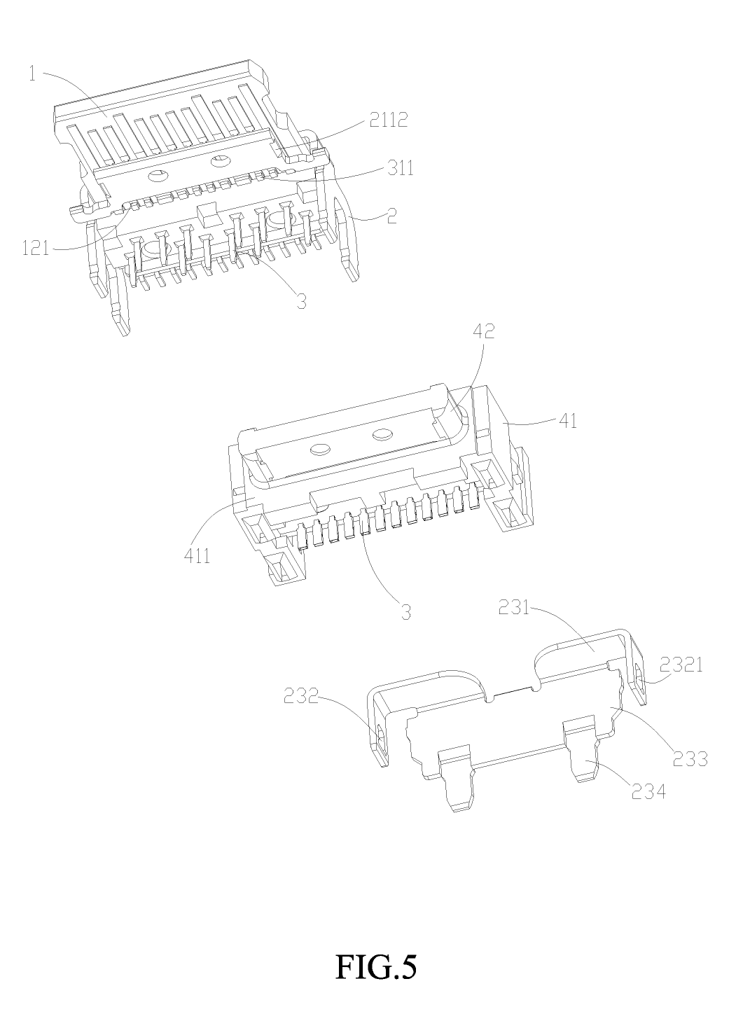

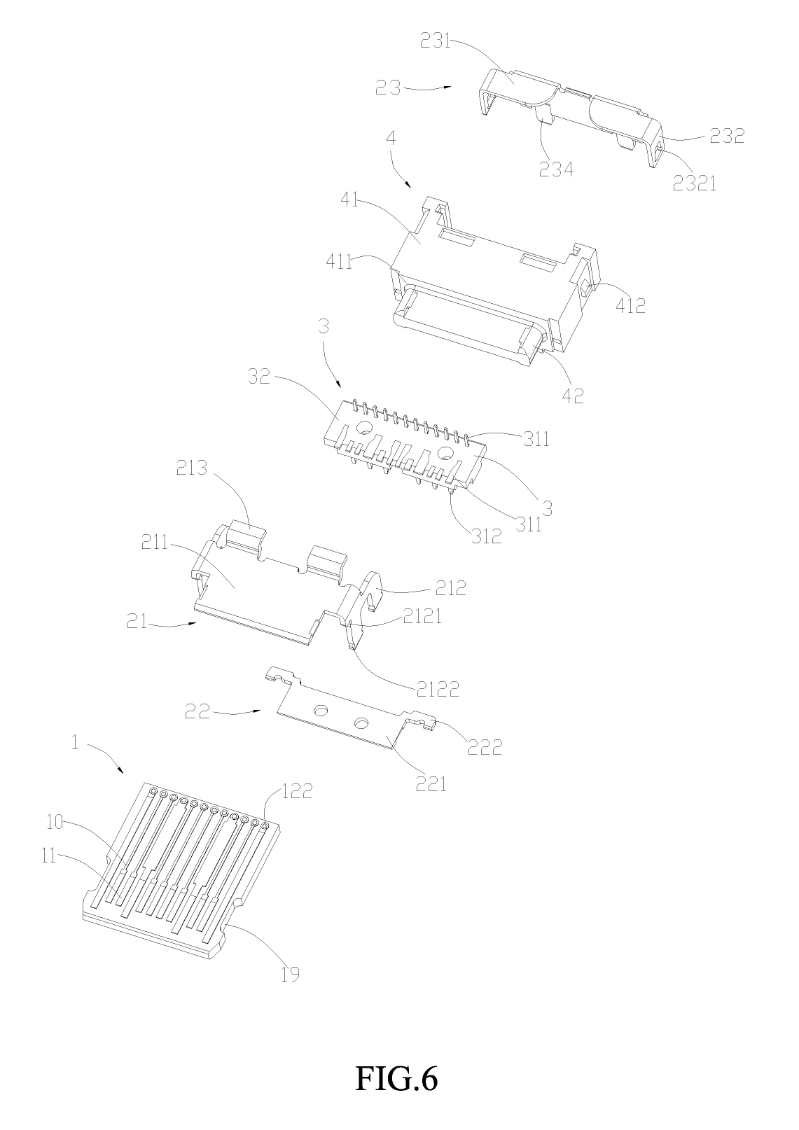

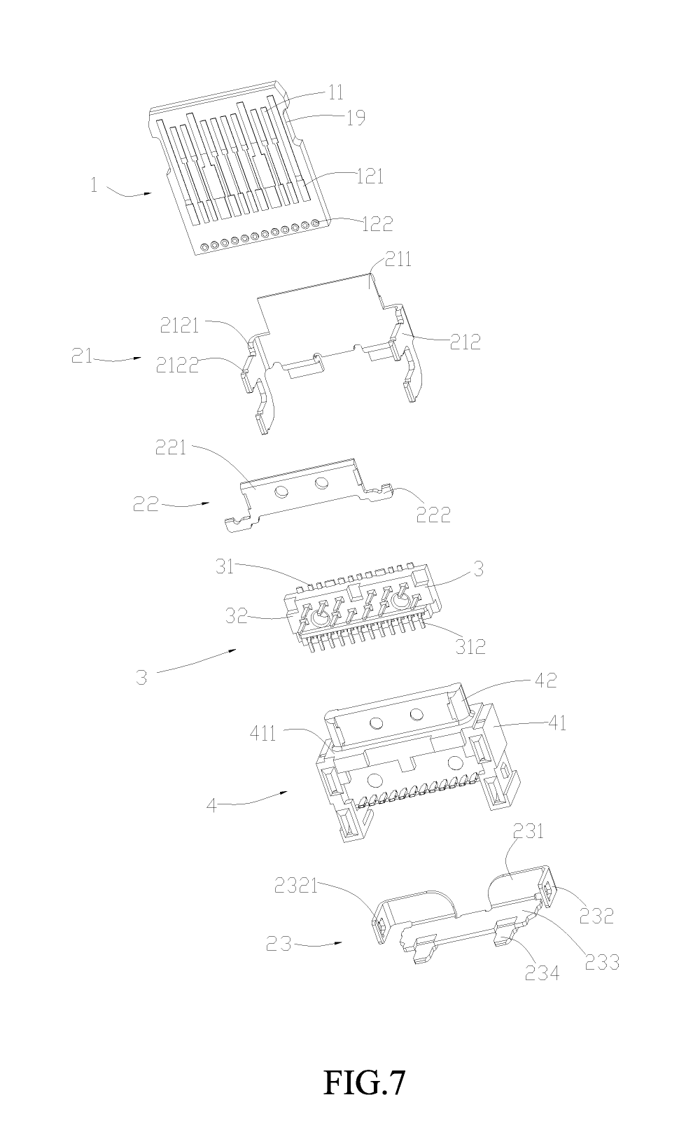

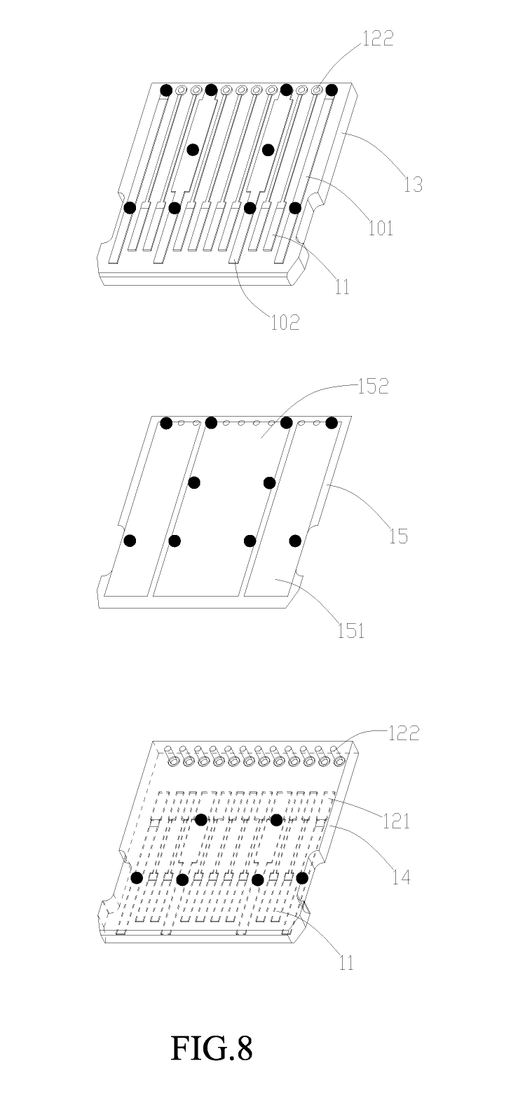

Please referring to FIG. 1 to FIG. 8, the present invention is directed to an electrical connector 100 mounting to a mother board (not shown) for mating with a mating connector (not shown). The electrical connector 100 includes an internal circuit board 1, a shielding assembly 2, a contact module 3 electrically connected the internal circuit board 1 with the mother board, and an insulative housing 4 surrounding the internal circuit board 1 and the contact module 3.

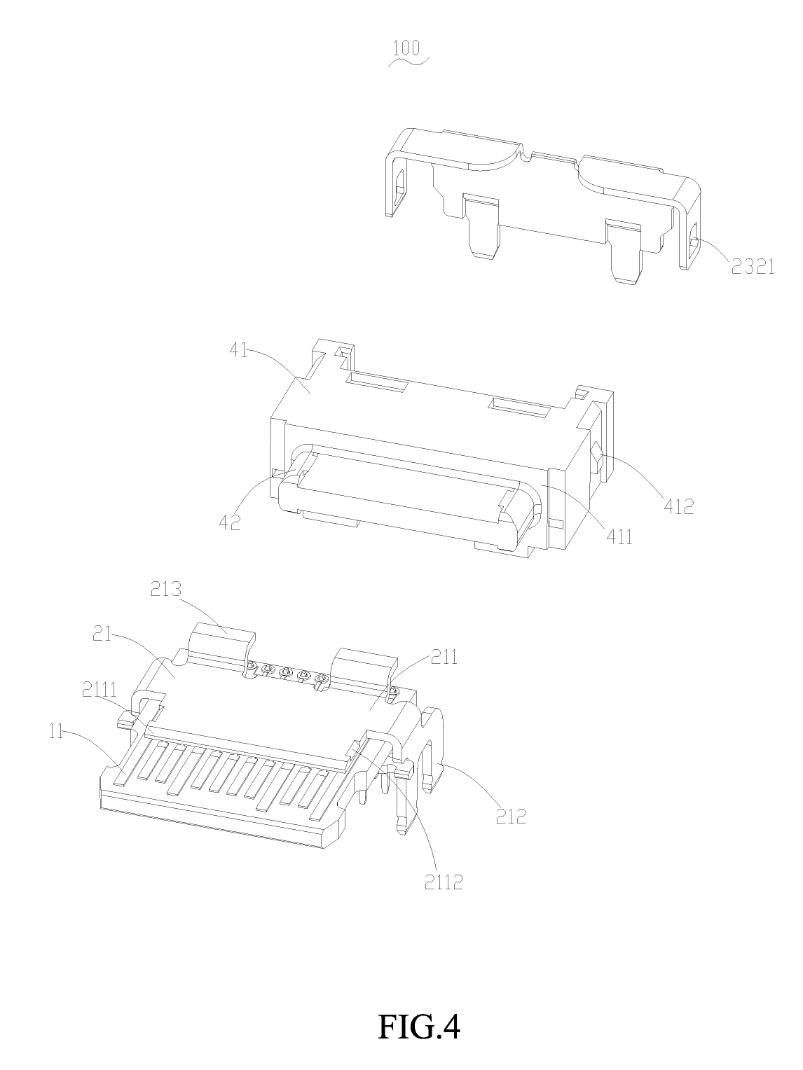

Please refer to FIG. 4 to FIG. 8, the internal circuit board 1 includes a plurality of first golden fingers 11 at a front end thereof, a plurality of second golden fingers 121 and a plurality of soldering holes 122 at a rear end thereof, and a plurality of conductive traces (not labeled) connected with the first golden fingers 11 with the second golden fingers 121 or the soldering holes 122. The first golden fingers 11, the conductive traces, and the corresponding second golden fingers 121 or soldering holes 122 form a plurality of electrical circuits connected with a plurality of electrical contacts 31 of the contact module 3 respectively.

The configuration of the electrical connector 100 conforms to USB Type-C, and the first golden fingers 11 and the conductive traces are arranged on both top and bottom surface of the internal circuit board 1. The second golden fingers 121 are arranged in the bottom surface of the internal circuit board 1 and the soldering holes 122 extend through the internal circuit board 1. A pair of notches 19 is provided on opposite sides of the internal circuit board 1.

The internal circuit board 1 has a top layer 13, a bottom layer 14, and a grounding layer 15 located between the top layer 13 and the bottom layer 14. The first golden fingers 11, the second golden fingers 121/soldering holes 122 and the conductive traces are disposed on the top and bottom layers 13, 14. The bottom layer 14 and the top layer 13 each include two grounding circuits 101 at outermost sides and a plurality of signal circuits located between the grounding circuits 101. The signal circuits includes two pair of high frequency signal circuits adjacent to the grounding circuits 101 respectively, two power circuits 102 at inner side of the high frequency signal circuits and four low frequency signal circuits located between the two power circuits 102. The electrical circuits on the top layer 13 and the bottom layer 14 are similar but disposed in opposite directions.

The grounding layer 15 has two grounding copper foils 151 at opposite sides thereof and a middle copper foil 152 located between the grounding copper foils 151. The grounding copper foils 15 are sandwiched by the high frequency signal circuits and the grounding circuits 101 of the top layer 13 and the bottom layer 14 thereby preventing crosstalk between the top layer 13 and the bottom layer 14. The grounding copper foils 151 extend into the notches 19 so as to contact with grounding tabs (not shown) of the complementary plug. Furthermore, the grounding circuits 101 of the top and bottom layers 13, 14 electrically connected with the grounding copper foils 151 via a plurality of plated-through holes (not labeled) to establish a grounding path and improve shielding.

The middle copper foil 152 is sandwiched by the power circuits 102 of the top layer 13 and the bottom layer 14. The middle copper foil 152 contacts with the power circuits 102 respectively via plated-through holes (not labeled) thereby form two parallel power paths between the top and bottom layers 13, 14 and decrease the resistance for transmitting biggish current. The present invention is provided with an internal circuit board which facilitates to manufacture and has improved transmitting speed.

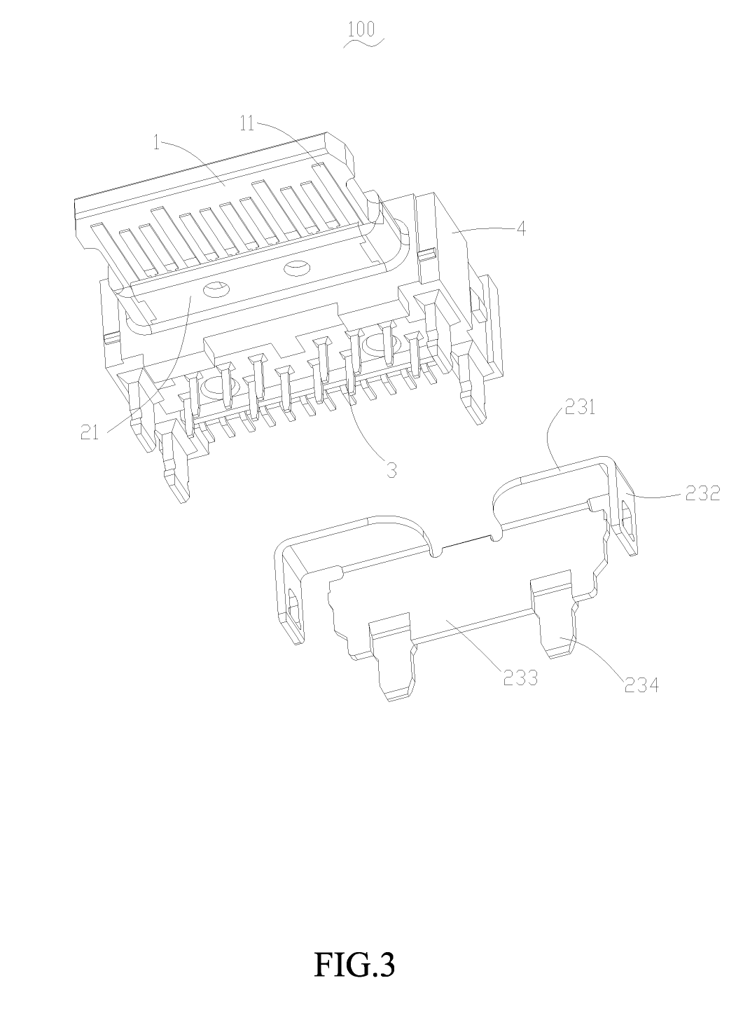

Please further refer to FIG. 3 to FIG. 8, the contact module 3 is attached to a rear end of the internal circuit board 1 and includes a base 32 and the electrical contacts 31 are secured to the base 32. The electrical contacts 31 are insert-molding with the base 32 and are arranged in two groups named first contacts and second contacts for contacting with the top layer 13 and the bottom layer 14 respectively. Each of the contacts 31 has a connecting section 311 connecting with the second golden fingers 121 or the soldering holes 122 and a solder tail 312 extending out of the base 32 and soldered to the mother board. The connecting sections 311 of the first contacts extend into the soldering holes 122 and electrically connect with the electrical circuits of the top surface. The connecting sections 311 of the second contacts are paralleled to the internal circuit board 1 and contact with the second golden fingers 121 on the bottom surface of the internal circuit board 1.

Please refer to FIG. 1 to FIG. 7, the shielding assembly 2 includes a first shell 21, a second shell 22 and a third shell 23. The first shell 21 and the second shell 22 cover the top and bottom surfaces of the internal circuit board 1 respectively and connect with the grounding circuits 101 of the top and bottom layers 13, 14. The conductive circuits except the grounding circuits 101, namely the signal circuits are coated with insulation paint for preventing the first and second shell 21, 22 from directly contacting with those circuits.

The first shell 21 has an upper plate 211 covering the top surface of the internal circuit board 1, two pair of grounding tails 212 extending downwardly from opposite sides of the upper plate 211 and a plurality of tabs 213 projecting upwardly from a rear edge of the upper plate 211. The upper plate 211 is provided a slant face 2111 at a front edge thereof for guiding the mating connector inserted therein. The upper plate 211 has a pair of gaps 2112 so that plastic is embedded therein when the first shell 21 injection molding with the insulative housing 4. The first shell 21 defines a pair of cutouts 2121 on the top of the grounding tails 212. Each of the grounding tails 212 has a pair of notches 2122 for receiving soldering materials therein when the electrical connector 100 is soldered to the mother board.

The second shell 22 has a lower plate 221 covering the bottom surface of the internal circuit board 1 and a pair of retention tabs 222 at opposite sides of the lower plate 221 and inserted into the pair of cutouts 2121 of the first shell 21. The first shell 21 and the second shell 22 of the present invention are independent, as alternative; they also could be integrated and surround the internal circuit board 1.

The insulative housing 4 is injection molding with the internal circuit board 1, the first shell 21 and the second shell 22 and the contact module 3. The insulative housing 4 has a base 41 surrounding rear ends of the first and second shells 21, 22 and the contact module 3, and a front portion 42 formed at two sides of the first and second shells 21, 22. The base 41 has a stop face at a front end thereof for abutting against the mating electrical connector. A pair of blocks 412 protrudes outwardly from two opposite sidewalls of the base 41.

The third shell 23 of the shielding assembly 2 is attached to the insulative housing 4 and has a connecting section 231, a pair of retention sections 232 bending downwardly from opposite sides of the connecting section 231, a covering section 233 bending downwardly from a rear edge of the connecting section 231 and a plurality of grounding tails 234 extending downwardly from the covering section 233 for soldering to the mother board. The retention section 232 is provided with a retention hole 2321 for engaging with the block 412 of the insulative housing 4.

After assembling, the first shell 21 and the second shell 22 project out of the insulative housing 4 and are exposed to an exterior. The tabs 213 are exposed to a top surface of the base 41 and contact the connecting section 231 thereby forms a grounding path between the first shell 21 and the third shell 23. The first shell 21 and the second shell 22 are located at top and bottom sides of the internal circuit board 1 and cover the conductive traces of the internal circuit board 1. The internal circuit board 1 projects forwardly beyond the first shell 21 and the second shell 22 with the first golden fingers 11 exposed to the exterior.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector for mounting to a mother board and mating with a plug, comprising:
an internal circuit board including a plurality of first golden fingers at a front end thereof and a plurality of conductive traces corresponding to the first golden fingers and connected with the first golden fingers respectively;
a shielding assembly having a first shell and a second shell together covering top and bottom surfaces of the internal circuit board; and
a contact module electrically connected with the internal circuit board.

2. The electrical connector as claimed in claim 1, wherein the first golden fingers and the conductive traces form a plurality of electrical circuits, and wherein the electrical circuits includes a plurality of grounding circuits and the first shell and the second shell contact with the grounding circuits.

3. The electrical connector as claimed in claim 2, wherein the first shell has an upper plate covering the top surface of the internal circuit board, a plurality of grounding tails extending downwardly from the upper plate, a plurality of tabs projecting upwardly from the upper late and a pair of cutouts defined on the grounding tails, and wherein the second shell has a lower plate covering the bottom surface of the internal circuit board and a pair of retention tabs inserted into the pair of cutouts.

4. The electrical connector as claimed in claim 1, wherein the first shell and the second shell are integrated shell and surround the conduct traces of the internal circuit board.

5. The electrical connector as claimed in claim 1, wherein the internal circuit board includes a plurality of second golden fingers and a plurality of soldering holes at a rear end thereof and corresponding to the first golden fingers, and wherein the contact module has plurality of electrical contacts electrically connected with the second golden fingers or the soldering holes.

6. The electrical connector as claimed in claim 1, further comprising an insulated housing injection molding with the first and second shells and the contact module, and wherein the first shell and the second shell project out of the insulative housing and are exposed to an exterior, and wherein the shielding assembly has a third shell shielding a rear portion of the insulative housing and contact with the first shell.

7. The electrical connector as claimed in claim 2, the internal circuit board has a top layer, a bottom layer, and a grounding layer located between the top layer and the bottom layer, and wherein the first golden fingers and the conductive traces are disposed on the top and bottom layers.

8. The electrical connector as claimed in claim 7, wherein the bottom layer and the top layer each has a plurality of signal circuits located between the grounding circuits, and wherein the signal circuits include two pair of high frequency signal circuits adjacent to the grounding circuits respectively, two power circuits at inner side of the high frequency signal circuits and four low frequency signal circuits located between the two power circuits, and wherein the electrical circuits on the top layer and the bottom layer are similar but disposed in opposite directions.

9. The electrical connector as claimed in claim 8, wherein the grounding layer has two grounding copper foils at opposite sides thereof and sandwiched by the high frequency signal circuits and the grounding circuits of the top layer and the bottom layer, and wherein the grounding circuits electrically connected with the grounding copper foils via a plurality of plated-through holes.

10. The electrical connector as claimed in claim 9, wherein the grounding layer has a middle copper foil located between the grounding copper foils and sandwiched by the power circuits of the top layer and the bottom layer, and wherein the middle copper foil contacts with the power circuits respectively via plated-through holes.

11. An electrical connector for mounting to a mother board and mating with a plug, comprising:
an internal circuit board including a plurality of first golden fingers at a front end thereof and a plurality of conductive traces connected with the first golden fingers;
a shielding assembly including a first shell, a second shell and a third shell, the first and second shell surrounding the top and bottom surfaces of the internal circuit board;
a contact module including a plurality of electrical contacts electrically connected with the first golden fingers and the conductive traces of the internal circuit board, and a base securing the electrical contacts; and
an insulative housing surrounding the first shell, the second shell and the contact module, the third shell surrounding a rear portion of the insulative housing.

12. The electrical connector as claimed in claim 11, wherein the first golden fingers and the conductive traces form a plurality of electrical circuits, and wherein the electrical circuits include a plurality of grounding circuits and a plurality of signal circuits.

13. The electrical connector as claimed in claim 12, wherein the signal circuits are coated with insulation paint so as to prevent the first and second shell from directly contacting with the signal circuits.

14. The electrical connector as claimed in claim 12, wherein the first shell has an upper plate contacting the ground circuits disposed in the top surface of the internal circuit board, a plurality of grounding tails extending downwardly from the upper plate and a pair of cutouts, and the second shell has a lower plate contacting the ground circuits disposed in the bottom surface of the internal circuit board and a pair of retention tabs engaging with the pair of cutouts.

15. The electrical connector as claimed in claim 14, wherein the insulated housing is injection molding with the first shell, the second shell and the contact module, and wherein the first shell and the second shell project out of the insulative housing and sandwich the conductive traces of the internal circuit board therebetween, and the third shell shielding a rear portion of the insulative housing and contacting with the first shell.

16. The electrical connector as claimed in claim 11, wherein the internal circuit board projects forwardly beyond the first shell and the second shell with the first golden fingers exposed to an exterior.

17. The electrical connector as claimed in claim 11, wherein the electrical circuits includes a plurality of second golden fingers and a plurality of soldering holes at a rear end of the internal circuit board and corresponding to the first golden fingers, and wherein the electrical contacts electrically connected with the second golden fingers or the soldering holes respectively.

18. The electrical connector as claimed in claim 12, wherein the internal circuit board has a top layer, a bottom layer, and a grounding layer located between the top layer and the bottom layer, and wherein the first golden fingers and the conductive traces are disposed on the top and bottom layers, and wherein the signal circuits include two pair of high frequency signal circuits adjacent to the grounding circuits respectively, two power circuits at inner side of the high frequency signal circuits and four low frequency signal circuits located between the two power circuits, and wherein the electrical circuits on the top layer and the bottom layer are similar but disposed in opposite directions.

19. The electrical connector as claimed in claim 18, wherein the grounding layer has two grounding copper foils at opposite sides thereof and a middle copper foil located between the grounding copper foils, and wherein the internal circuit board is provided with a plurality of plated-through holes to electrically connect the grounding circuits with the grounding copper foils and the middle copper foil contacts with the power circuits.

20. The electrical connector as claimed in claim 19, wherein the grounding copper foils are sandwiched by the high frequency signal circuits and the grounding circuits of the top layer and the bottom layer, and the middle copper foil is sandwiched by the power circuits of the top layer and the bottom layer.
